(19) United States
(12) Patent Application Publication
(10) Pub. No.: US 2020/0319111 A1
(43) Pub. Date: Oct. 8, 2020

(54) RAMAN SPECTRUM INSPECTION APPARATUS, AND SAMPLE SECURITY INSPECTING METHOD FOR RAMAN SPECTRUM INSPECTION

(71) Applicant: NUCTECH COMPANY LIMITED, Beijing (CN)

(72) Inventors: Hongqiu Wang, Beijing (CN); Jiaqian Zuo, Beijing (CN); Haihui Liu, Beijing (CN); Jianhong Zhang, Beijing (CN)

(21) Appl. No.: 16/314,172

(22) PCT Filed: Dec. 21, 2018
(86) PCT No.: PCT/CN2018/122870

§ 371 Date: Dec. 28, 2018

(30) Foreign Application Priority Data
Dec. 26, 2017 (CN) 201711439073.0

(51) Int. Cl. G01N 21/65; G06K 9/46; H04N 5/372; H04N 9/04; G06K 9/62

(52) U.S. Cl. CPC G01N 21/65; G06K 9/4642; G01N 2201/06113; H04N 9/045; G06K 9/6212; H04N 5/372

(57) ABSTRACT

A Raman spectrum inspection apparatus and a sample security inspecting method for Raman spectrum inspection are provided. The Raman spectrum inspection apparatus includes: an exciting light source configured to emit an exciting light to a sample; an optical device having a spectrum inspection optical path and a sample imaging optical path, wherein the spectrum inspection optical path is configured to collect a light signal from a location where the sample is irradiated by the exciting light, and the sample imaging optical path is configured to take an image of the sample; a spectrometer configured to receive a light signal from the spectrum inspection optical path, and to generate a Raman spectrum of the sample from the light signal; and a sample security decision device configured to determine security of the sample based on the image of the sample that is taken by the sample imaging optical path.

### CROSS-REFERENCE TO RELATED APPLICATION

This application is a national phase application of PCT/CN2018/122870, filed Dec. 21, 2018 and claims the priority of Chinese Patent Application No. 201711439073.0 filed on Dec. 26, 2017 with the China National Intellectual Property Administration, the entire disclosure of which is incorporated herein by reference.

### BACKGROUND OF THE DISCLOSURE

### Field of the Disclosure

Embodiments of the present disclosure relate to the field of Raman spectrum inspection, and more particularly to a Raman spectrum inspection apparatus and a sample security inspecting method for Raman spectrum inspection.

### Description of the Related Art

Raman spectrum analysis technology is a non-contact spectrum analysis technology based on Raman scattering effect, which can analyse compositions of substances qualitatively and quantitatively. Raman spectrum is a molecular vibration spectrum that can reflect fingerprint features of molecules and that may be used to detect substances. Raman spectrum inspection detects and recognizes substances by detecting a Raman spectrum produced by the Raman scattering effect of an object to be inspected with an exciting light. Raman spectrum inspecting method has been applied widely in the fields of liquid security inspection, jewelry inspection, explosives inspection, drug inspection, medicine inspection, pesticide residue inspection, etc.

In recent years, the Raman spectrum analysis technology has been applied widely in the fields of inspection of hazardous articles and recognition of substances. In the field of substance recognition, people usually are unable to judge the properties of substances accurately because various substances have different colors and shapes. The Raman spectrum depends on level structure of molecules of an object to be inspected, thus the Raman spectrum may be used as “fingerprint” information of substances for substance recognition. Therefore, Raman spectrum analysis technology has been applied widely in the fields of customs, public safety, food, medicine, environment, etc.

Raman spectrum requires a laser with high power density as an exciting light source, which may have a strong thermal effect. Thus, in a case that the sample is unknown, a rash inspection may cause the sample to be damaged or ablated by the laser, and may even cause ignition or detonation of some flammable and explosive chemicals by the laser, which lead to a loss in human body or properties.

### SUMMARY OF THE DISCLOSURE

An embodiment of the present disclosure provides a Raman spectrum inspection apparatus, including:

an exciting light source configured to emit an exciting light to a sample to be inspected;

an optical device having a spectrum inspection optical path and a sample imaging optical path, wherein the spectrum inspection optical path is configured to collect a light signal from a location where the sample to be inspected is irradiated by the exciting light, and the sample imaging optical path is configured to take an image of the sample to be inspected;

a spectrometer configured to receive a light signal from the spectrum inspection optical path and to generate a Raman spectrum of the sample to be inspected from the light signal; and

a sample security decision device configured to determine security of the sample to be inspected based on the image of the sample to be inspected that is taken by the sample imaging optical path.

In an embodiment, the sample imaging optical path includes a supplementary lighting lamp, an imaging device, and a camera, wherein the supplementary lighting lamp is configured to irradiate the sample to be inspected, and the imaging device is configured to project the image of the sample to be inspected to the camera.

In an embodiment, the spectrum inspection optical path includes in order: a collection lens, a beam splitter, a Raman filter group, and a coupling lens, wherein the imaging device in the sample imaging optical path includes the collection lens, the beam splitter, and a focus lens group, and wherein the collection lens and the beam splitter are common components of the spectrum inspection optical path and the imaging device.

In an embodiment, the camera is a CCD camera having color channels of red, green, and blue.

In an embodiment, the sample security decision device includes:

a color histogram generating module configured to generate histograms of a plurality of colors according to the image of the sample to be inspected that is taken by the sample imaging optical path;

a color level ratio calculating module configured to calculate a ratio of an amount of pixels within a predetermined color level range in the histogram of each color to a total amount of pixels of the image; and

a comparison module configured to compare the ratio of pixels within the predetermined color level range in the histogram of each color to the total amount of pixels of the image with a predetermined threshold, wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

In an embodiment, the histograms of the plurality of colors include histograms of red, green, and blue colors.

In an embodiment, the Raman spectrum inspection apparatus further includes: a controller configured to start the exciting light source to emit a light signal in a case that the sample security decision device determines that the sample to be inspected is safe, and to stop the exciting light source from emitting the light signal in a case that the sample security decision device determines that the sample to be inspected is unsafe.

An embodiment of the present disclosure provides a sample security inspecting method for Raman spectrum inspection, including:

taking an image of a sample to be inspected by using a sample imaging optical path;

generating histograms of a plurality of colors of the image;

calculating a ratio of amount of pixels within a predetermined color level range in the histogram of each color to a total amount of pixels of the image; and

comparing the ratio of amount of pixels within the predetermined color level range in the histogram of each color to the total amount of pixels of the image with a predetermined threshold,

wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

In an embodiment, the histograms of the plurality of colors include histograms of red, green, and blue colors.

In an embodiment, the generating histograms of a plurality of colors of the image includes:

reading image information of each color channel of the image, and recording the image information of each color channel into a color matrix, wherein elements in the matrix are in one-to-one correspondence with the pixels of the image;

dividing the levels of colors into a plurality of intervals, and counting an amount of elements within each interval in each color matrix, thereby forming histograms of the plurality of colors.

In an embodiment, a number of color levels in each interval is between 1 and 25.

In an embodiment, the predetermined color level range is 0 to m, wherein m is an integer with a value between 10 and 60.

In an embodiment, the predetermined threshold is greater than or equal to 0.72 and less than or equal to 0.98.

In an embodiment, the method further includes:

starting the Raman spectrum inspection in a case that it is determined that the sample to be inspected is safe, and stopping the Raman spectrum inspection in a case that it is determined that the sample to be inspected is unsafe.

### BRIEF DESCRIPTION OF THE DRAWINGS

FIG. 1 shows a schematic diagram of a Raman spectrum inspection apparatus according to an embodiment of the present disclosure;

FIG. 2 shows a flow chart of a sample security inspecting method according to an embodiment of the present disclosure;

FIG. 3 shows an example of a color histogram of an image of a sample inspected by a sample security inspecting method according to an embodiment of the present disclosure;

FIG. 4 shows an example of a color histogram of an image of another sample inspected by a sample security inspecting method according to an embodiment of the present disclosure; and

FIG. 5 shows an example of a color histogram of an image of a yet further sample inspected by a sample security inspecting method according to an embodiment of the present disclosure.

All of circuits and structures in the security inspection apparatus, which inspects an object, of the embodiment according to the present disclosure are not shown. Same reference numerals represent same or similar components or features throughout all of the figures.

### DETAILED DESCRIPTION OF THE EMBODIMENTS

Technical solutions of the present disclosure will be described hereinafter in more detail by the way of embodiments with reference to the attached drawings. Same or similar reference numerals refer to same or similar components throughout the description. The following explanation to the embodiments of the present disclosure with reference to the attached drawings is intended to interpret a general concept of the present disclosure, rather than being construed as a limiting to the present disclosure.

Additionally, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawings.

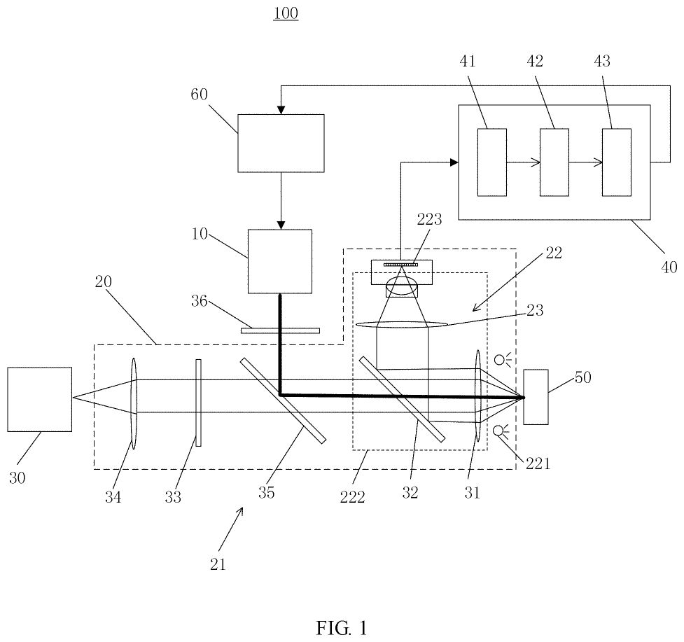

An embodiment of the present disclosure provides a Raman spectrum inspection apparatus 100. As shown in FIG. 1, the Raman spectrum inspection apparatus 100 includes an exciting light source 10, an optical device 20, a spectrometer 30, and a sample security decision device 40. The exciting light source 10, which may include a laser for example, is configured to emit an exciting light to a sample 50 to be inspected. The optical device 20 has two optical paths, i.e., a spectrum inspection optical path 21 and a sample imaging optical path 22. The spectrum inspection optical path 21 is configured to collect a light signal from a location where the sample 50 to be inspected is irradiated by the exciting light. The collected light signal may be transmitted to the spectrometer 30. The spectrometer 30 may be configured to receive a light signal from the spectrum inspection optical path 21, and to generate a Raman spectrum of the sample 50 to be inspected from the light signal, thereby implementing a normal flow of the Raman spectrum inspection. The sample imaging optical path 22 is configured to take an image of the sample 50 to be inspected, which is then transmitted to the sample security decision device 40. The sample security decision device 40 may be configured to determine the security of the sample 50 to be inspected based on the image of the sample 50 to be inspected that is taken by the sample imaging optical path 22.

As mentioned above, acquiring optical signals by using the exciting light is a basic step in the Raman spectrum inspection of a sample to be inspected, and the exciting light itself has a certain amount of energy. For a sample to be inspected of some materials, it may react with the exciting light, resulting in some changes in the composition of the sample. For example, some flammable and explosive materials may be ignited, ablated, detonated and so on under the action of the exciting light. In practice, the composition of the sample to be inspected is usually unknown, therefore it needs to inspect the security of the sample to be inspected before formal light signal acquisition and measurement. In the Raman spectrum inspection apparatus 100 according to an embodiment of the present disclosure, the security of the sample to be inspected is determined by the appearance of the sample 50 to be inspected. It is indicated in practice that samples to be inspected, which may be easily ignited, ablated or detonated by an exciting light, are substantially dark in color, such as black. For this reason, by analysing the image of the sample 50 to be inspected, the security of the sample to be inspected may be determined to some extent. Once it is found that the sample to be inspected may have a security problem, it is possible to stop a normal operation of the Raman spectrum inspection apparatus immediately so as to avoid danger.

In an example, in order to better obtain a clear image of the sample to be inspected, the sample imaging optical path 22 may include a supplementary lighting lamp 221, an imaging device 222, and a camera 223. The supplementary lighting lamp 221 is mainly used to provide sufficient light intensity for taking images of the sample to be inspected. Usually, the sample to be inspected is close to a component (e.g., a collection lens) at a front end of the optical device during the Raman inspection process, therefore, the external ambient light is not easy to sufficiently irradiate the sample to be inspected. In this case, the role of the supplementary lighting lamp is especially important. The supplementary lighting lamp 221 is configured to irradiate the sample to be inspected, for example, by various lamps known in the art, such as halogen lamps, incandescent lamps, LED lamps, etc., which are capable of providing sufficient irradiation intensity. The imaging device 222 is configured to project an image of a sample 50 to be inspected to the camera 223. In order to achieve better imaging, the imaging device 222 may include, for example, a collection lens 31, a focus lens group 23, etc. In the example of FIG. 1, the focus lens group 23 is composed of two lenses, but this is merely exemplary, and the embodiments of the present disclosure are not limited to this. The focus lens group 23 may be composed of any amount of lenses, or may be formed by any lens group that is known in the art and capable of achieving clear imaging.

In an example, the spectrum inspection optical path 21 may include in order: a collection lens 31, a beam splitter 32, a Raman filter group 33, and a coupling lens 34. The imaging device 222 in the sample imaging optical path 22 includes the collection lens 31, the beam splitter 32, and a focus lens group 23. The spectrum inspection optical path 21 and the imaging device 222 share the collection lens 31 and the beam splitter 32 as their common components. As an example, the Raman filter group 33 may include one or more optical filters for filtering undesired light such as Rayleigh scattering light and the exciting light, while preserving the Raman scattering light signal. The coupling lens 34 may be used to couple the light signal, which has been filtered by the Raman filter group 33, to the spectrometer 30. In the example shown in FIG. 1, the spectrum inspection optical path 21 and the sample imaging optical path 22 have a common portion close to the sample 50 to be inspected. The beam splitter 32 allows the light signal from the sample 50 to be inspected to pass through to the spectrometer, thereby forming the spectrum inspection optical path 21. The beam splitter 32 reflects the light beam, which has an image of the sample to be inspected, to form a sample imaging optical path 22. It should be noted that, though the spectrum inspection optical path 21 and the sample imaging optical path 22 have a common portion, this does not mean that the operations of spectrum inspection and sample imaging must be performed simultaneously, for example, the sample imaging operation is usually performed before the spectrum inspection, so that the security of the sample to be inspected is determined before the spectrum inspection to avoid danger during the spectrum inspection. As an example, the optical path of the exciting light source 10 that emits the exciting light may also partly coincide with the spectrum inspection optical path 21, for example, as shown in FIG. 1, another beam splitter 35 may be provided, which may reflect the exciting light emitted from the exciting light source 10. The reflected exciting light is concentrated on the sample 50 to be inspected by the collection lens 31, which helps to simplify the adjustment of the optical path. However, the embodiments of the present disclosure are not limited to this, for example, the light emitted from the exciting light source 10 may pass through a light path, which is completely independent from the spectrum inspection optical path, to irradiate the sample to be inspected. As an example, the exciting light may further pass through a stray light removal filter 36 after it is emitted from the exciting light source 10. The stray light removal filter 36 may be used to remove stray light to increase an SNR (signal-to-noise ratio) of the exciting light.

The above example is merely an exemplary implementation of the Raman spectrum inspection apparatus, but the embodiments of the present disclosure are not limited to this. For example, the spectrum inspection optical path 21 and the sample imaging optical path 22 may also be completely independent from each other.

As an example, the camera 223 may be a CCD (Charge Coupled Device) camera having color channels of red, green, and blue. However, the embodiments of the present disclosure are not limited to this, and a camera having other color channels may also be used to acquire the above image.

As an example, the sample security decision device 40 may include a color histogram generating module 41, a color level ratio calculating module 42, and a comparison module 43. The color histogram generating module 41 may be configured to generate histograms of a plurality of colors according to the image of the sample 50 to be inspected that is taken by the sample imaging optical path 22. The color level (gradation) ratio calculating module 42 may be configured to calculate a ratio of an amount of pixels within a predetermined color level range in the histogram of each color to a total amount of pixels of the image. The comparison module 43 may be configured to compare the ratio of amount of pixels within the predetermined color level range in the histogram of each color to the total amount of pixels of the image with a predetermined threshold. In a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

As mentioned above, the security of the sample to be inspected for Raman spectrum inspection is greatly related to the color of the sample to be inspected. Therefore, by creating a color histogram of the image of the sample to be inspected, it may find out samples to be inspected, which have a specified color (e.g., black or dark color), to avoid potential inspection risks.

As an example, the histograms of the plurality of colors may include histograms of red, green, and blue colors. This may correspond to the camera 223 with red, green and blue colors. Usually, histograms of red, green, and blue colors are sufficient to reflect the color state of the image. However, the embodiments of the present disclosure are not limited to this, for example, the histograms of the plurality of colors may further include histograms of other colors such as yellow, cyan, etc., to adapt to different image information.

In an example, a Raman spectrum inspection apparatus according to an embodiment of the present disclosure may further include a controller 60. The controller 60 may be configured to start an exciting light source to emit a light signal if the sample security decision device 40 determines that the sample to be inspected is safe, and to stop the exciting light source from emitting a light signal if the sample security decision device determines that the sample to be inspected is unsafe. As an example, the controller 60 may be in communication with the sample security decision device 40. In a case that the sample security decision device 40 determines that the sample to be inspected is safe, the sample security decision device 40 may send a sample safe signal to the controller 60. After receiving this signal, the controller 60 sends a start signal to the exciting light source 10. In a case that the sample security decision device 40 determines that the sample to be inspected is unsafe, the sample security decision device 40 may send a sample dangerous signal to the controller 60. After receiving this signal, the controller 60 does not send a start signal to the exciting light source 10, or it sends a stop signal to the exciting light source 10.

As an example, both the sample security decision device 40 and the controller 60 may be implemented by a processor or other computing device.

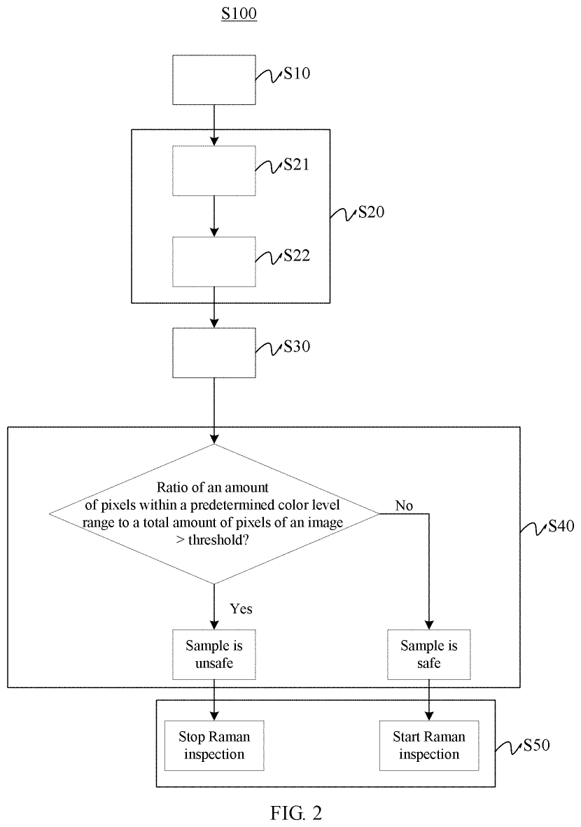

A sample security inspecting method for Raman spectrum inspection according to an embodiment of the present disclosure will be described below. As shown in FIG. 2, the sample security inspecting method S100 includes:

Step S10: taking an image of a sample to be inspected by using a sample imaging optical path;

Step S20: generating histograms of a plurality of colors of the image;

Step S30: calculating a ratio of an amount of pixels within a predetermined color level range in the histogram of each color to a total amount of pixels of the image; and

Step S40: comparing the ratio of the amount of pixels within the predetermined color level range in the histogram of each color to the total amount of pixels of the image with the predetermined threshold; in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

As an example, the histograms of the plurality of colors include histograms of red, green, and blue colors. In an example, the step S20 includes:

Step S21: reading image information of each color channel of the image, and recording the image information of each color channel into a color matrix, wherein elements in the matrix are in one-to-one correspondence with the pixels of the image;

and

Step S22: dividing the levels of colors into a plurality of intervals, and counting an amount of elements within each interval in each color matrix, thereby forming histograms of the plurality of colors.

As an example, the sample security inspecting method S100 may further include:

Step S50: starting the Raman spectrum inspection in a case that it is determined that the sample to be inspected is safe, and stopping the Raman spectrum inspection in a case that it is determined that the sample to be inspected is unsafe.

A specific calculation example is given below:

First, an image I of a sample to be inspected is acquired by using a CCD camera having color channels of red, green, and blue.

Then, a processor (e.g., a microprocessor (pP), a digital signal processor (DSP), etc.) is selected to read the image I acquired by the CCD camera.

Then, the image information of three color channels of red (R), green (G), and blue (B) of the image I is read sequentially, and recorded as IR, IG, and IB, wherein each of IR, IG, and IB represents a matrix. The elements of the matrix are in one-to-one correspondence with the pixels of the image. The number of rows of the matrix and the number of columns of the matrix are also the same as the number of rows of pixels of the image and the number of columns of pixels of the image, respectively.

Next, IR(i, j), IG(i, j), and IB(i, j) are read, where i, j represent a pixel of the i^{th} row and the j^{th} column of the acquired image, and i=1, 2, . . . , I.width, j=1, 2, . . . , I.length. The term “I.width” represents a number of columns of pixels, or is referred to as an amount of pixels in a width direction of the image, or an image width of the image; and “I.length” represents a number of rows of pixels, or is referred to as an amount of pixels in a length direction of the image, or a length of the image. An image size (i.e., a total amount of pixels) is recorded as Size=I.width*I.length, wherein “*” indicates a product sign.

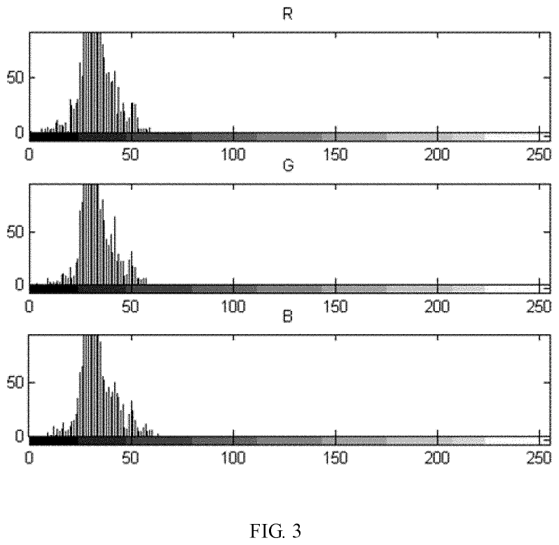

Then, the color level 0-255 is taken as the abscissa of the color histogram, and the color level is divided into N intervals, and the range of each interval BIN(n) is BIN(n)=[(n−1)*255/N, n*255/N], where n=1, 2, . . . , N, and “*” indicates a product sign, and “I” indicates a division sign. As shown in FIGS. 3 to 5, the color level is divided into 256 intervals, and a number of color level(s) within each interval is 1, and each color level is represented by one of the 256 integers between 0 and 255. However, the embodiments of the present disclosure are not limited to this. For example, the number of color levels within each interval may be between 1 and 25, and the number of color levels within each interval may be additionally determined according to actual needs.

Then, for the color channel of red, a number of occurrences of color levels in each interval BIN(n) in the image is counted. For example, the number of pixels that satisfy (n−1)*255/N≤IR(i, j)<n*255/N may be calculated by exhausting all pixels in the image, for example, by adding in an accumulated manner. Similarly, for the color channels of green and blue, the number of occurrences of color levels in the each interval BIN(n) in the image is also counted.

Next, it is determined whether each of the R, G, B color histograms of the interval [0, m] exceeds a threshold, where [0, m] represents a predetermined range of color levels, for example, a range of values of m may be [10, 60].

In order to determine whether the R, G, and B color histograms of the interval [0, m] exceed the threshold, it is necessary to calculate a ratio (or frequency) R of pixels within the predetermined color level range to the total amount of pixels of the image for the three colors of R, G, and B, respectively:

$$R = {\sum }_{k = 1}^{K} BIN ( k ) / Size ,$$

where K=N*m/256.

For example, in the examples in FIGS. 3 to 5, if it selects m=30, N=256, then K=N*m/256=256*30/256=30, that is, it counts the color histograms within the interval BIN(k) (k=1, 2, . . . , 30), and calculate the above ratio.

In order to determine whether the R, G, B color histograms of the interval [0, m] exceed the threshold, it is necessary to select a threshold Th. As an example, a range of the value of Th may be [0.72, 0.98]. In the examples shown in FIGS. 3 to 5, it selects Th=0.85. When all of the above ratios (represented by RR, RG, and RB, respectively) calculated for the R, G, and B colors are larger than the threshold, it is determined that the sample to be inspected may be substance with dark or black color, which may be dangerous for the sample to be inspected or the operator.

When the ratio of the amount of pixels within the predetermined color level range in the histogram of every color to the total amount of pixels of the image exceeds the threshold value, that is, when the sample or the sample surface is substance with dark or black color, it may be ablated after being irradiated by laser, so it is possible to stop the measurement and wait for the next measurement; otherwise, the recognition for Raman spectrum will be performed. As an example, when all of the RR, RG, and RB are larger than the threshold, the processor (e.g., a microprocessor (pP), a digital signal processor (DSP), etc.) may send a command signal to stop the laser light emission; otherwise, it continues to recognize the Raman spectrum.

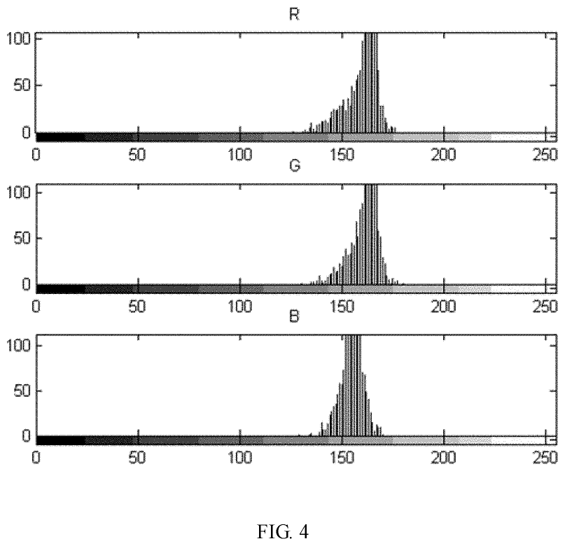

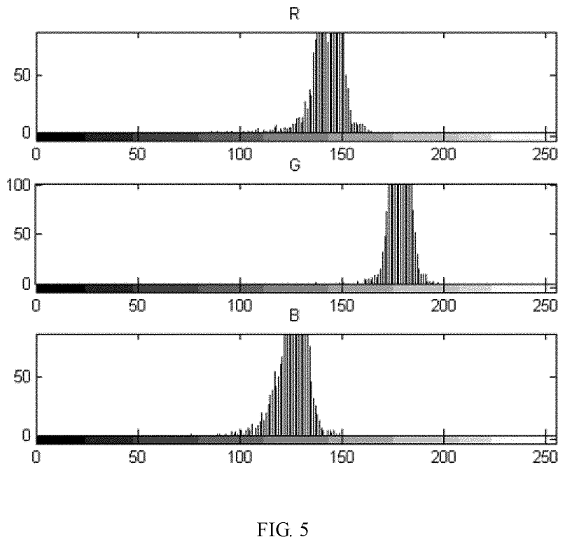

FIGS. 3 to 5 respectively show R, G, and B color histograms (listed in an order from top to bottom) for three different samples to be inspected, which are inspected according to the method as described above. The abscissa of FIGS. 3 to 5 is the color level, while the ordinate is the amount of samples (corresponding to the amount of pixels in the present embodiment). For the example shown in FIG. 3, all of the RR, RG, and RB of the Interval [0, 30] are larger than the threshold 0.85, so it may be determined that the sample may have a risk. For the examples in FIGS. 4 and 5, all of the RR, RG, and RB of the interval [0, 30] in the color histograms are far less than the threshold 0.85, so it may be determined that the sample does not have the risk.

By means of the Raman spectrum inspection apparatus and the sample security inspecting method for Raman spectrum inspection according to the aforementioned embodiments, it is possible to reduce or prevent an inspection risk that the sample is ignited, ablated or detonated by the exciting light during spectrum inspection. The above examples are merely for explaining the calculation process of determining the inspection risk of the sample to be inspected by using the color histogram of the image. The embodiments of the present disclosure are not limited to this, and other methods are also feasible as long as it may accurately determine the color of the sample to be inspected by the color histogram of the image.

The above description has explained various embodiments of the above inspection apparatus for inspecting the security of an object and a inspecting method thereof by schematic views, flow charts and/or examples. In case that the schematic views, flow charts and/or examples each include one or more functions and/or operations, the skilled person in the art should understand that each function and/or operation in such schematic views, flow charts and/or examples may be implemented separately and/or collectively by various structures, hardware, software, firmware or any combination of them in essential. In an embodiment, some parts of the subject of the embodiments of the present disclosure may be implemented by Application Specific Integrated Circuits (ASIC), Field Programmable Gate Arrays (FPGA), Digital Signal Processors (DSP) or other integrated forms. Nonetheless, the skilled person in the art should understand that some aspects of the embodiments disclosed herein may be implemented equally in the integrated circuit entirely or partly, implemented as one or more computer programs executed in one or more computers (e.g., implemented as one or more programs running on one or more computer systems), implemented as one or more programs running on one or more processors (e.g., implemented as one or more programs running on one or more microprocessors), implemented as firmware, or implemented as any combination of the above methods in essential. From the present disclosure, the skilled person in the art has capability of designing circuits and/or writing software and/or firmware codes. Furthermore, the skilled person in the art will appreciate that the mechanism of the subject of the present disclosure may be delivered as various forms of program products, and the exemplified embodiments of the subject of the present disclosure may be applicable independent of the specific types of the signal carrying media that perform the delivery in practice. Examples of the signal carrying media include, but not limited to: recordable media, such as a floppy disc, a hard disk drive, an optical disc (CD, DVD), a digital magnetic tape, a computer memory or the like; and transmission media such as digital and/or analogue communication media (for example, an optical fiber cable, a wave guide, a wired communication link, a wireless communication link, etc.).

Any of the above embodiments of the present disclosure may be combined freely to form other embodiments unless there are technical obstacles or contradictions. All of these other embodiments fall within the protection scope of the present disclosure.

Although the present disclosure has been explained with reference to the drawings, the embodiments shown in the drawings are only illustrative, instead of limiting the present disclosure. Scales in the drawings are only illustrative, instead of limiting the present disclosure.

Although some embodiments of the general inventive concept are illustrated and explained, it would be appreciated by those skilled in the art that modifications and variations may be made in these embodiments without departing from the principles and spirit of the general inventive concept of the present disclosure, the scope of which is defined in the appended claims and their equivalents.

1. A Raman spectrum inspection apparatus, comprising:
an exciting light source configured to emit an exciting light to a sample to be inspected;
an optical device having a spectrum inspection optical path and a sample imaging optical path, wherein the spectrum inspection optical path is configured to collect a light signal from a location where the sample to be inspected is irradiated by the exciting light, and the sample imaging optical path is configured to take an image of the sample to be inspected;
a spectrometer configured to receive a light signal from the spectrum inspection optical path and to generate a Raman spectrum of the sample to be inspected from the light signal; and
a sample security decision device configured to determine security of the sample to be inspected based on the image of the sample to be inspected that is taken by the sample imaging optical path.

2. The Raman spectrum inspection apparatus according to claim 1,
wherein the sample imaging optical path comprises a supplementary lighting lamp, an imaging device, and a camera, wherein the supplementary lighting lamp is configured to irradiate the sample to be inspected, and the imaging device is configured to project the image of the sample to be inspected to the camera.

3. The Raman spectrum inspection apparatus according to claim 2, wherein the spectrum inspection optical path comprises in order: a collection lens, a beam splitter, a Raman filter group, and a coupling lens,
wherein the imaging device in the sample imaging optical path comprises the collection lens, the beam splitter, and a focus lens group, and
wherein the collection lens and the beam splitter are common components of the spectrum inspection optical path and the imaging device.

4. The Raman spectrum inspection apparatus according to claim 2, wherein the camera is a CCD camera having color channels of red, green, and blue.

5. The Raman spectrum inspection apparatus according to claim 1, wherein the sample security decision device comprises:
a color histogram generating module configured to generate histograms of a plurality of colors according to the image of the sample to be inspected that is taken by the sample imaging optical path;
a color level ratio calculating module configured to calculate a ratio of an amount of pixels within a predetermined color level range in the histogram of each color to a total amount of pixels of the image; and
a comparison module configured to compare the ratio of pixels within the predetermined color level range in the histogram of each color to the total amount of pixels of the image with a predetermined threshold,
wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

6. The Raman spectrum inspection apparatus of claim 5, wherein the histograms of the plurality of colors comprise histograms of red, green, and blue colors.

7. The Raman spectrum inspection apparatus according to claim 1, further comprising:
a controller configured to start the exciting light source to emit a light signal in a case that the sample security decision device determines that the sample to be inspected is safe, and to stop the exciting light source from emitting the light signal in a case that the sample security decision device determines that the sample to be inspected is unsafe.

8. A sample security inspecting method for Raman spectrum inspection, comprising:
taking an image of a sample to be inspected by using a sample imaging optical path;
generating histograms of a plurality of colors of the image;
calculating a ratio of amount of pixels within a predetermined color level range in the histogram of each color to a total amount of pixels of the image; and
comparing the ratio of amount of pixels within the predetermined color level range in the histogram of each color to the total amount of pixels of the image with a predetermined threshold,
wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

9. The method according to claim 8, wherein the histograms of the plurality of colors comprise histograms of red, green, and blue colors.

10. The method according to claim 8, wherein said generating histograms of a plurality of colors of the image comprises:
reading image information of each color channel of the image, and recording the image information of each color channel into a color matrix, wherein elements in the matrix are in one-to-one correspondence with the pixels of the image;
dividing the levels of colors into a plurality of intervals, and counting an amount of elements within each interval in each color matrix, thereby forming histograms of the plurality of colors.

11. The method according to claim 10, wherein a number of color levels in each interval is between 1 and 25.

12. The method according to claim 10, wherein the predetermined color level range is 0 to m, wherein m is an integer with a value between 10 and 60.

13. The method according to claim 10, wherein the predetermined threshold is greater than or equal to 0.72 and less than or equal to 0.98.

14. The method according to claim 8, further comprising:
starting the Raman spectrum inspection in a case that it is determined that the sample to be inspected is safe, and stopping the Raman spectrum inspection in a case that it is determined that the sample to be inspected is unsafe.

15. The Raman spectrum inspection apparatus according to claim 2, wherein the sample security decision device comprises:
a color histogram generating module configured to generate histograms of a plurality of colors according to the image of the sample to be inspected that is taken by the sample imaging optical path;
a color level ratio calculating module configured to calculate a ratio of an amount of pixels within a predetermined color level range in the histogram of each color to a total amount of pixels of the image; and
a comparison module configured to compare the ratio of pixels within the predetermined color level range in the histogram of each color to the total amount of pixels of the image with a predetermined threshold,
wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

16. The Raman spectrum inspection apparatus of claim 15, wherein the histograms of the plurality of colors comprise histograms of red, green, and blue colors.

17. The Raman spectrum inspection apparatus according to claim 3, wherein the sample security decision device comprises:
a color histogram generating module configured to generate histograms of a plurality of colors according to the image of the sample to be inspected that is taken by the sample imaging optical path;
a color level ratio calculating module configured to calculate a ratio of an amount of pixels within a predetermined color level range in the histogram of each color to a total amount of pixels of the image; and
a comparison module configured to compare the ratio of pixels within the predetermined color level range in the histogram of each color to the total amount of pixels of the image with a predetermined threshold,
wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

18. The Raman spectrum inspection apparatus of claim 17, wherein the histograms of the plurality of colors comprise histograms of red, green, and blue colors.

19. The Raman spectrum inspection apparatus according to claim 4, wherein the sample security decision device comprises:
a color histogram generating module configured to generate histograms of a plurality of colors according to the image of the sample to be inspected that is taken by the sample imaging optical path;
a color level ratio calculating module configured to calculate a ratio of an amount of pixels within a predetermined color level range in the histogram of each color to a total amount of pixels of the image; and
a comparison module configured to compare the ratio of pixels within the predetermined color level range in the histogram of each color to the total amount of pixels of the image with a predetermined threshold,
wherein in a case that the ratio of the amount of pixels within the predetermined color level range in the histogram of every color to the total amount of pixels of the image exceeds the predetermined threshold, it is determined that the sample to be inspected is unsafe; otherwise, it is determined that the sample to be inspected is safe.

20. The Raman spectrum inspection apparatus of claim 19, wherein the histograms of the plurality of colors comprise histograms of red, green, and blue colors.
